(19) United States
(12) Patent Application Publication
(10) Pub. No.: US 2007/0018846 A1
(43) Pub. Date: Jan. 25, 2007

(54) Remote multiple vehicle starting method and device

(76) Inventor: Andrew Taraian, Bridgeport, CT (US)

Correspondence Address: Thomas J. Monahan;Monahan & Costello, LLC., Attorneys at Law, 4154 Madison Avenue, Trumbull, CT, 06611, US

(21) Appl. No.: 11/490,425

(22) Filed: Jul. 20, 2006

Related U.S. Application Data
(60) Provisional application No. 60/701,007, filed on Jul. 20, 2005.

(51) Int. Cl. G08C 19/00

(52) U.S. Cl. 340/825.69; 340/5.2; 340/5.64; 123/179.2; 123/179.3; 340/3.1

(57) ABSTRACT

System and method for remote starting of multiple vehicles. The present invention is directed to systems and methods for remotely starting and monitoring multiple vehicles. Optimized multiple computer control of vehicle warm-up procedures, and optionally monitoring procedures, provides cost savings as well as safety and environmental advantages. In a preferred embodiment, the invention relates to pre-heating, pre-cooling and reducing the idle time of school buses.

This application claims priority from U.S. Provisional Application No. 60/701,007 filed Jul. 20, 2005.

### BACKGROUND OF THE INVENTION

1. Field of the Invention

The present invention relates to remote control and safety monitoring of vehicles.

More specifically, the invention relates to vehicles that are located in motor pools, including cars, trucks, buses, school buses and construction vehicles that have a specific need for engine starting for the purposes of vehicle pre-heating or pre-cooling as well as fuel consumption minimization by timing the initial start of the bus to the minimum time period permissible and with integration of various vehicle safety checks. The invention describes various embodiments, sensing methods and systems. In a most preferred embodiment, the invention relates to automated pre-heating, pre-cooling and reducing the idle time of school buses with essential vehicle system safety checks.

2. Description of the Prior Art

A variety of vehicle engine starters, including remote vehicle starting devices, are known in the art. Various remote engine starter systems and methods are described in U.S. Pat. Nos. 6,871,624; 6,853,895, 6,662,085, 6,559,558; 6,147,418; 5,990,800; 5,942,988; and 5,937,065.

What is needed are remote starter systems that are capable of controlling multiple vehicles for starting and safety evaluation simultaneously or in close time proximity.

Preferably, what is needed are devices and methods for remotely starting vehicle motor pools responsive to specific environmental and essential vehicle system safety requirements, preferably school buses, that require heat or cooling temperature pre-conditioning of vehicle interiors prior to vehicle operation or transport of occupants. In light of current technology, there is a need to optimize present vehicle pre-starting regimes for safety reasons and for reasons of fuel conservation with concomitant reduction of internal combustion atmospheric pollutants. With present concern with the rising cost of fuel and the environmental effects arising from the combustion fuel, there is a compelling need to reduce fuel costs, to minimize fuel consumption, and simultaneously to maintain the safety of essential vehicle systems. The present invention is directed toward solving these needs.

Accordingly, it is an object of the present invention to provide a method for coordinated starting of multiple vehicles in a motor pool.

It is another object of the present invention to provide a device and method for coordinated starting of multiple vehicles in a motor pool responsive to variable ambient temperatures and atmospheric conditions.

Another object of the present invention is to provide a device and method that integrates safety evaluations of essential vehicle operating systems in coordination with the starting of multiple vehicles.

These and other objects and advantages of the present invention and equivalents thereof, are achieved by the methods and devices of the present invention described herein and manifest in the appended claims.

### SUMMARY OF THE INVENTION

Although the present invention describes in detail certain embodiments, it is understood that variations and modification exist known to those skilled in the art to which this invention applies that are within the invention. Accordingly, the present invention is intended to encompass all such alternatives, modifications and variations that are within the scope of the invention as set herein. Specific terminology used in the description of specific embodiments is for the purpose of illustration and not to limit the scope of the invention.

Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

The present invention is directed to multi-vehicle systems and methods for remotely starting motor vehicles, preferably pools of motor vehicles, especially school buses via the usage of on vehicle embedded electronics (receivers; transmitters; transceivers) that communicate wirelessly with a central computer system remotely located some distance from the fleet of buses or other vehicles. The vehicles may be any type of land, sea or air motor vehicle that requires optimized engine and/or vehicle interior temperature pre-conditioning prior to operation or mass transport of vehicle passenger. The remote or wireless starting of vehicles is under computer control. Environmental variants such as weather conditions (e.g., external temperature) in concert with time-to-operation requirements are inputted to the centralized computer control system. Optionally, information from the subject vehicles on condition-based maintenance safety parameters (i.e., condition of engine oil, coolant, battery, tire pressure, lights, brakes, hood, doors, windows etc.) may be remotely queried by the centralized computer control system and inputted into the computer control system's data base.

The present invention is particularly directed toward the remote starting of school buses that require pre-heating or pre-cooling of the vehicle interior prior to the transport of students. The systems and methods of the invention result in significant advantages in the form of fuel savings and also provide a technical base for adding additional electronic functions to school buses such as remote reporting of vehicle maintenance needs, vehicle operational characteristics and the eventual incorporation of vehicle safety functions such as on bus video camera recording or the like.

The present invention provides a method for remotely starting a plurality of vehicles in a motor pool that comprises identifying the current weather conditions; identifying the departure time requirements for each of the plurality of vehicles; determining the optimum time for warm-up of the engines of the plurality of vehicles based upon said current weather conditions; transmitting wirelessly from a centralized control unit remotely located from the motor pool vehicles to individual vehicles of the plurality of vehicles customized start signals based upon require time of departure and warm-up requirements of the engines of the vehicles; receiving the transmitted customized start signals in control units of the plurality of vehicles; and thereafter starting the plurality of motor vehicles in a coordinated fashion based upon time of departure requirement in view of engine warm-up requirements. The current weather conditions are temperatures, and/or temperatures and atmospheric conditions. Atmospheric conditions are ice, frost, humidity, fog, snow, freezing rain, and combinations thereof. Vehicles are selected from the group of buses, trucks, and construction vehicles. A preferred embodiment of the invention is school buses.

The present invention also provides a method for condition-based monitoring of a plurality of vehicles. Information on the condition of vehicles is preferably transmitted wirelessly from sensors located in critical systems/subsystems of the vehicles to a centralized control unit. Condition-based sensor information may conveniently be obtained from any system or subsystem, including but not limited to the master switch; light switches; heaters; hood; brakes; fuel supply; tire pressure; oil pressure; glo plug; coolant; turn signals; hazard lights; tachometer; battery; speedometer; geographical position; and any combinations of these systems or subsystems. When vehicles such as buses have diesel engines, information on the condition of diesel engine glo plugs is preferably transmitted to the central control unit prior to remotely starting the engines of the buses or other vehicles. When vehicles are school buses, information on the master switch is transmitted. The master switch is preferably in the Off position so as not to drain power. With buses the 8-way light switch is preferably shut off. Also, with school buses information is preferably transmitted on the heaters (i.e., the front heater is generally left On and the rear heater is left Off). If condition-based monitoring of vehicle systems/subsystems is not required, a vehicle transceiver may be replaced with a receiver.

Also, the present invention provides a system for remotely starting a plurality of vehicles in a motor pool that has: (i) a computer-controlled central unit with a radio frequency transceiver that is remotely located from the motor pool of vehicles (i.e., buses); (ii) sensors located in vehicle systems or subsystems; and (iii) transceiver units located in the motor pool vehicles capable of receiving remote engine start signals from the central unit and transmitting condition based maintenance information from the system/subsystem sensors. Sensors are located in any essential system or subsystem or motor pool vehicles, including but not limited to, the master switch; light switches; heaters; hood; brakes; fuel supply; tire pressure; oil pressure; glo plug; coolant; turn signals; hazard lights; tachometer; battery; speedometer; geographical position; and any combination of these systems/subsystems.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawing should not be read to constitute limiting requirements, but instead are intended to assist the reader in understanding the invention.

FIG. 1 is a schematic diagram of the starter control system with various input information.

FIG. 2 is a schematic diagram of a vehicle control center that is remotely or wirelessly linked to multiple vehicles.

FIG. 3 is a top view of a control unit for assembly into a vehicle.

FIG. 4 is a cut-away perspective view of a control unit for assembly into a vehicle.

### DETAILED DESCRIPTION OF THE INVENTION

By way of background, in the United States there are currently about 600,000 school buses in operation. Approximately 12-15% of these buses are replaced each year. Currently, school buses are co-located in motor pool areas (bus yards) and, during extremes of temperature, are started manually each day prior to starting bus runs and transporting students. School buses are typically powered by diesel engines that average 5 to 6 miles per gallon during operation. Diesel Fuel consumption of school buses while they are idling is about 1 gallon per hour. With contemporary school bus engine starting procedures for the purpose of interior temperature preconditioning (i.e., heating of the bus passenger compartment during the winter months and cooling during the summer months), there are several associated costs. Firstly, there is the cost of the fuel to run the buses at idle for temperature pre-condition. There is also a labor cost as personnel are required to manually start the school buses for pre-heating or pre-cooling each day prior to the arrival of the bus drivers and initiation of school bus routes. As each bus yard is independently insured, there is an insurance cost associated with insuring the personnel starting the buses for temperature pre-conditioning (i.e., workman‘s’ compensation insurance). Motor pool vehicles may be powered by internal combustion engines, diesel engines, hybrid engines or fuel cells.

In addition to school bus or other vehicle passenger compartment temperature regulation concerns, there are vehicle safety issues that require monitoring. For example, the condition of oil (i.e., quantity; pressure), battery, coolant, brake fluid, brakes, lights, fuel supply, diesel glo plug, tires, windows, hoods, doors, etc. that must be checked. This inspection of vehicles for such safety factors is currently done manually.

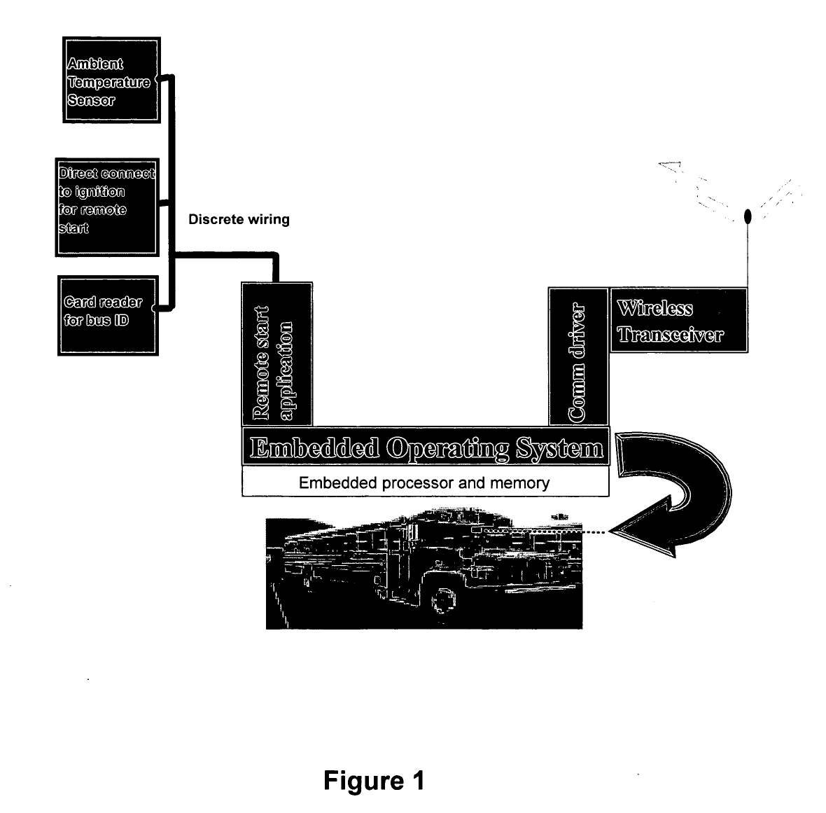

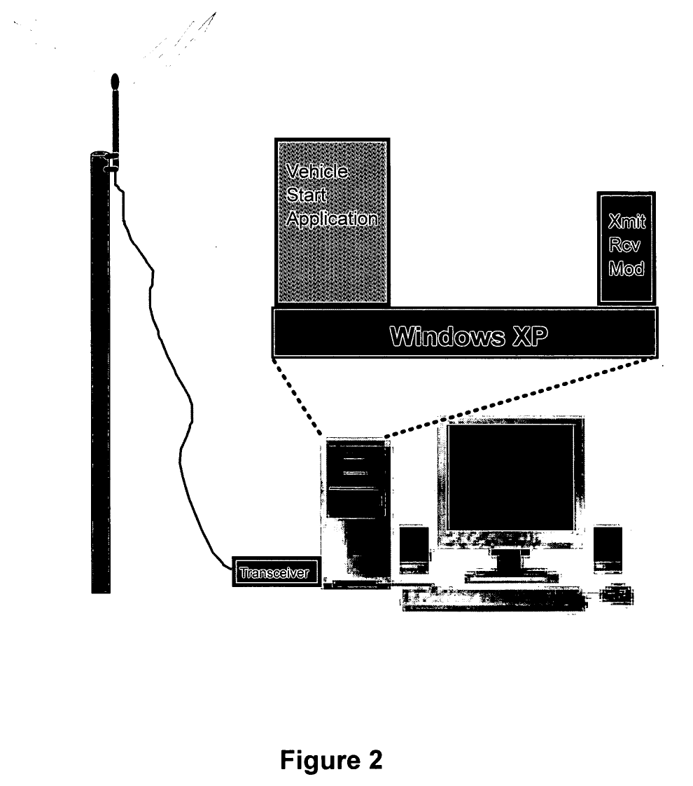

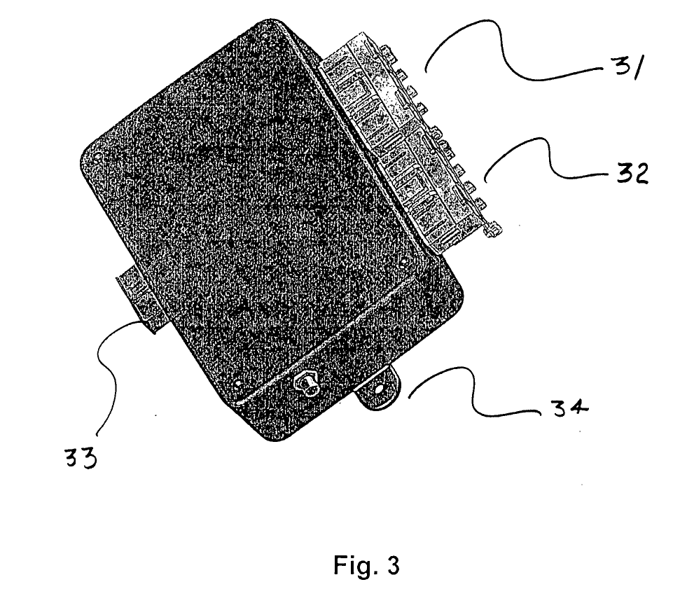

The present invention provides a multi-vehicle remote starting system. As illustrated in FIGS. 1 and 2, the invention has a centralized computer control system (Vehicle Control Center) that is able to communicate with an unlimited number of vehicles simultaneously for starting all the vehicles. In the case of school buses, the average number of vehicle starts would be approximately 50-200 vehicles, or more. The invention is not limited by the number of vehicles that are in a motor pool (i.e., bus lot). Referring now more particularly to FIG. 3, shown is a control unit for assembly into a vehicle. Shown is harness 31, harness 32, harness 33, and a bracket 34 for attachment to the vehicle. For example, in a bus, the unit would be attached under the dashboard. Harnesses have a plurality of attachment means. The unit of FIG. 3 is for use in a school bus. Harness 31 has five attachment means (i.e., a start position on Ignition switch attachment; a ground; a spare attachment for any selected function; a 12 volt power attachment; and another spare attachment. Harness 32 also has five attachment means (i.e., a 12 volt power attachment; a run position on ignition switch; a spare attachment; attachment wires from ACC position on ignition switch; ACC position on ignition switch). Harness 33 has ten attachment means (i.e., ground; ACC from ignition switch; tachometer input; glow plug; brake switch sensor; three spares; dashboard toggle switch; and a second ground).

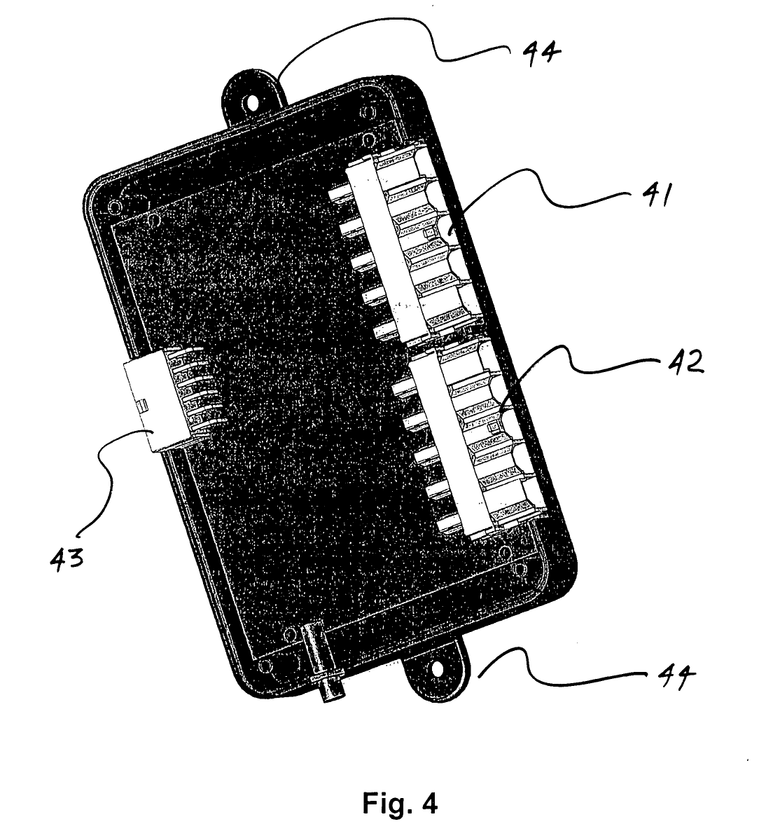

Referring now more particularly to FIG. 4, shown is a cut-away perspective view of the same bus unit that is shown in FIG. 3. Shown is harness 41; harness 42; harness 43; and bracket 44 for attachment of the unit under the dashboard of the bus.

Weather conditions are provided to the control system. For specific outdoor temperatures and a record of recent atmospheric conditions (i.e., the low temperatures of the preceding night), it is a straightforward calculation to determine the ideal time that each bus will have to idle to achieve a desired passenger compartment temperature. The system of the invention maintains computer records correlating atmospheric conditions with idealized vehicle engine idle time. If the outdoor temperature is extremely cold or extremely hot, it will take longer to warm-up or cool the passenger compartment than more moderate temperature. Once the precise warm-up temperature is obtained, the vehicle is ready for passengers. The present invention will optimize the bus or other engine idle time of operation to achieve desired passenger compartment temperatures. This is in contrast to current procedures where, for example, school buses are run at idle for warm-up for arbitrary times which in practice are significantly longer than necessary to achieve desired passenger compartment temperatures. This excess of warm-up time accounts for unnecessary use of fuel. With a centralized control system, once the buses or other vehicles reach required interior temperatures, the engine can be shut off by remote/wireless control.

The present invention provides a means for identifying and implementing optimized engine idle times for motor pool vehicles that may start vehicles over a variable schedule. For example, in a school bus pool, not all buses leave at the same time (i.e., 10 buses may leave at 6:00 am; 10 buses may leave at 6:30 am, etc.). The method and system of the inventions conveniently coordinate vehicle starting times with required departure times.

The present invention has a wireless remote vehicle fleet starter and remote control and scheduling software for controlling vehicles preferably equipped with automatic transmissions that are commonly powered by either gasoline or diesel engines. Diesel engines are commonly used with school buses. From a centralized control, you are able to remotely view the status of the vehicle (i.e., required systems are operative), and to schedule vehicles to start automatically based on the time of the day, the day of the week, the ambient temperature/atmospheric conditions, or any combination of these variables. The transmitter of the invention is preferably a radio frequency transmitter that will remotely start vehicles over an extended range (i.e., up to about 1 mile). Wi-Fi transmitters may be used, but are generally limited to short distances.

Optionally, the system and devices of the invention may receive and monitor essential additional vehicle information via a connection to an on vehicle bus such as J1939 to determine various parameters of the engine and drive train. Any vehicle system or subsystem that may be equipped with a sensor for wireless transmission may be monitored. Typical functions that may be monitored include but are not limited to, oil pressure, coolant temperature, brake fluid, brakes, lights, fuel supply, tires, windows, hoods, doors, and the like. For example, oil pressure, coolant and battery information may be transmitted to the centralized computer control system in addition to temperature/weather information. The computer control system of the invention is equipped with customized software to interpret input information from vehicles and advise the system operator or automatically perform certain functions. For example, if the school bus shows improper oil pressure, improper coolant temperature, improper battery strength, etc. the bus can be identified by report or otherwise and/or automatically shut-down and disqualified for pupil transport. Computer timers are set by environmental degree days to provide appropriate engine warming.

One of the main advantages of the present invention is to provide a cost-effective system and method to municipalities that operate school buses. By automating and optimizing the warm-up process, significant fuel saving over the course of the school year can be obtained. There are environmental benefits from such fuel saving in the form of reducing emissions. This is of particular concern in urban environments as in addition to carbon dioxide and other gaseous emissions, diesel engine emissions have higher amounts of oxides of nitrogen and particulates than emission from gasoline engines. The fuel and associated financial saving in switching from set warm-up school bus engine operation to optimized timing of warm-up engine operation under computer control will on average likely be greater over the course of the school year in colder regions than in warmer regions.

Although the present invention describes in detail certain embodiments, it is understood that variations and modifications exist known to those skilled in the art that are within the invention. Accordingly, the present invention is intended to encompass all such alternatives, modifications and variations that are within the scope of the invention as set forth in the following claims:

What is claimed is:

1. A method for remotely starting a plurality of vehicles in a motor pool comprising:
identifying the current weather conditions;
identifying the departure time requirements for each of said plurality of vehicles;
determining the optimum time for warm-up of the engines of said plurality of vehicles based upon said current weather conditions;
transmitting wirelessly from a centralized control unit remotely located from said motor pool vehicles to individual vehicles of said plurality of vehicles customized start signals based upon require time of departure and warm-up requirements of the engines of said vehicles;
receiving said transmitted customized start signals in control units of said plurality of vehicles; and
starting said plurality of motor vehicles in a coordinated fashion based upon time of departure requirement in view of engine warm-up requirements.

2. The method of claim 1, wherein said current weather conditions are temperatures.

3. The method of claim 1, wherein said current weather conditions are temperatures and atmospheric conditions.

4. The method of claim 1, wherein said atmospheric conditions are selected from the group of ice, frost, humidity, fog, snow, freezing rain, and combinations thereof.

5. The method of claim 1, wherein said vehicles are selected from the group of buses, trucks, and construction vehicles.

6. The method of claim 1, wherein said vehicles are school buses.

7. The method of claim 1, further comprising condition-based monitoring of said plurality of vehicles.

8. The method of claim 7, wherein information on the condition of said vehicles is transmitted wirelessly from sensors in said vehicles to said centralized control unit.

9. The method of claim 8, wherein said condition-based sensor information is selected from the group of: master switch; light switches; heaters; hood; brakes; fuel supply; tire pressure; oil pressure; glo plug; coolant; turn signals; hazard lights;
tachometer; battery; speedometer; geographical position; and combinations thereof.

10. The method of claim 8, wherein said vehicles have diesel engines and information on the condition of diesel engine glo plugs is transmitted prior to remotely starting the engines of said vehicles.

11. The method of claim 8, wherein said vehicles are school buses and said information on the master switch is transmitted.

12. The method of claim 8, wherein said vehicles are school buses and said information transmitted is on the heaters.

13. A system for remotely starting a plurality of vehicles in a motor pool comprising:
a computer-controlled central unit having a radio frequency transceiver remotely located from said plurality of vehicles;
sensors located in vehicle systems or subsystems; and
transceiver units located in said plurality of vehicles capable of receiving remote engine start signals from said central unit and transmitting condition based maintenance information from said sensors.

14. The system of claim 13, wherein said sensors are located in the group of:
master switch; light switches; heaters; hood; brakes; fuel supply; tire pressure; oil pressure; glo plug; coolant; turn signals; hazard lights; tachometer; battery; speedometer;
geographical position; and combinations thereof.
